(19) United States
(12) Patent Application Publication
(10) Pub. No.: US 2016/0312088 A1
(43) Pub. Date: Oct. 27, 2016

(54) ADHESIVE COMPOSITIONS CONTAINING MODIFIED ETHYLENE-BASED POLYMERS AND COMPATIBLE TACKIFIERS

(71) Applicant: DOW GLOBAL TECHNOLOGIES LLC, Midland, MI (US)

(72) Inventors: Kate R. Brown, Houston, TX (US); Selim Yalvac, Pearland, TX (US); Colin LiPiShan, Pearland, TX (US)

(73) Assignees: Dow Global Technologies LLC, Midland, MI (US); Dow Global Technologies LLC, Midland, MI (US)

(21) Appl. No.: 15/101,346

(22) PCT Filed: Dec. 23, 2014
(86) PCT No.: PCT/US14/72208

§ 371 Date: Jun. 2, 2016

Related U.S. Application Data
(60) Provisional application No. 61/920,936, filed on Dec. 26, 2013.

(51) Int. Cl. C09J 151/06; C09J 11/08; C09J 9/00

(52) U.S. Cl. CPC C09J 151/06; C09J 9/00; C09J 11/08

(57) ABSTRACT

The invention provides a composition comprising the following components: A) an anhydride and/or carboxylic acid functionalized ethylene/alpha-olefin interpolymer having the following properties: i) a melt viscosity (177 C) less than, or equal to, 50,000 cP, ii) a density from 0.855 to 0.900 g/cc; B) a tackifier selected from the following: a) a hydrocarbon tackifier that has a cloud point (DACP) temperature greater than, or equal to, 20 C, b) a rosin ester tackifier with an acid number of less than 25, c) a terpene tackifier, or d) a combination thereof.

### REFERENCE TO RELATED APPLICATIONS

This application claims the benefit of U.S. Provisional Application No. 61/920,936, filed Dec. 26, 2013.

### BACKGROUND

Adhesives based on polyolefins have experienced considerable growth over the last decade, due to their good performance, processability, and, in some cases, cost benefits. Adhesive formulations are described in the following references: WO2007/146875, U.S. Pat. No. 7,645,829, U.S. Pat. No. 7,223,814B2, U.S. Pat. No. 6,858,667B1, U.S. Pat. No. 5,763,516A, U.S. Pat. No. 5,458,982A, U.S. Pat. No. 5,441,999A, JP04991710B2 (abstract), JP3046514B (abstract), JP2052668B (abstract), JP1029830B (abstract), JP2008069295A (abstract), JP61181882A (abstract) and JP55066981A (abstract). However, there remains a need for new adhesive compositions that have improved adhesion to “hard-to-bond” substrates.” These needs have been met by the following invention.

### SUMMARY OF THE INVENTION

The invention provides a composition comprising the following components:

A) an anhydride and/or carboxylic acid functionalized ethylene/alpha-olefin interpolymer having the following properties:
i) a melt viscosity (177° C.) less than, or equal to, 50,000 cP,
ii) a density from 0.855 to 0.900 g/cc;

B) a tackifier selected from the following:
a) a hydrocarbon tackifier that has a cloud point (DACP) temperature greater than, or equal to, 20° C.,
b) a rosin ester tackifier with an acid number of less than 25,
c) a terpene tackifier, or
d) a combination thereof.

### BRIEF DESCRIPTION OF THE DRAWINGS

FIG. 1 depicts the apparatus used to determined cloud point for an adhesive composition.

FIG. 2 depicts transmittance versus temperature of a composition containing AFFINITY GA 1900 and STAYBELITE 10E.

FIG. 3 depicts the derivative of transmittance versus temperature of a composition containing AFFINITY GA 1900 and STAYBELITE 10E.

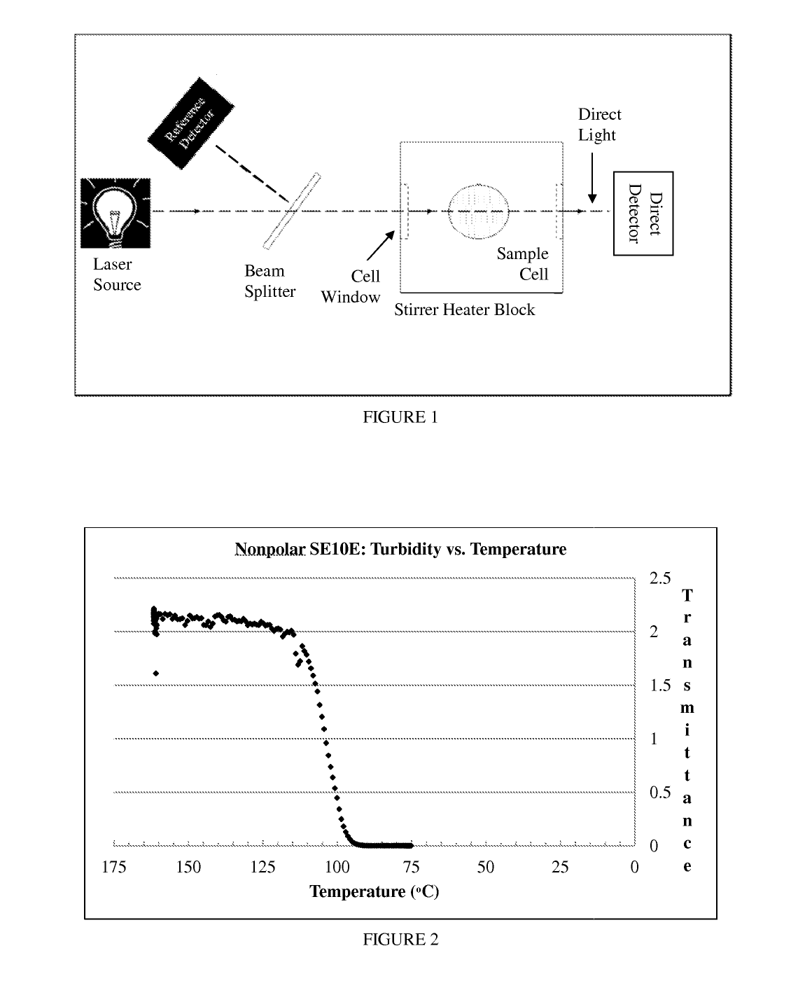

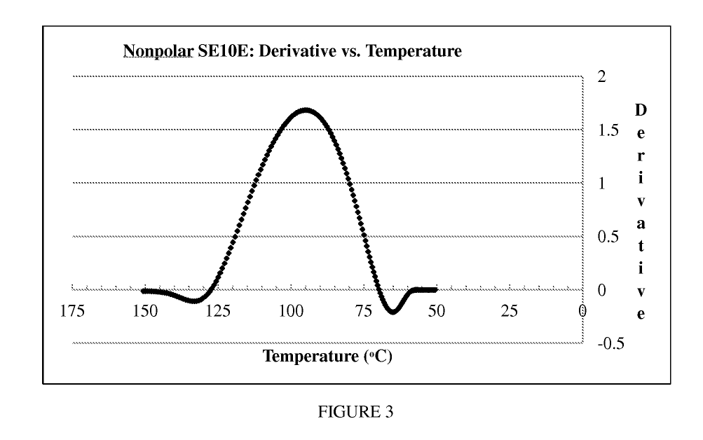

### DETAILED DESCRIPTION

As discussed above, the invention provides a composition comprising the following components:

A) an anhydride and/or carboxylic acid functionalized ethylene/alpha-olefin interpolymer having the following properties:
i) a melt viscosity (177° C.) less than, or equal to, 50,000 cP,
ii) a density from 0.855 to 0.900 g/cc;

B) a tackifier selected from the following:
a) a hydrocarbon tackifier that has a cloud point (DACP) temperature greater than, or equal to, 20° C.,
b) a rosin ester tackifier with an acid number (i.e., a number given in mg of KOH necessary to neutralize 1.0 g of the acid) of less than 25,
c) a terpene tackifier, or
d) a combination thereof.

The inventive composition may comprise a combination of two or more embodiments as described herein.

In one embodiment, the tackifier is selected from the following:
a) a hydrocarbon tackifier that has a cloud point (DACP) temperature greater than, or equal to, 20° C.,
b) a rosin ester tackifier with an acid number of less than 25, or
c) a terpene tackifier.

In one embodiment, the tackifier is selected from the following:
a) a hydrocarbon tackifier that has a cloud point (DACP) temperature greater than, or equal to, 20° C.,
b) a rosin ester tackifier with an acid number of less than 25, or
d) a combination thereof.

In one embodiment, the tackifier is selected from the following:
a) a hydrocarbon tackifier that has a cloud point (DACP) temperature greater than, or equal to, 20° C., or
b) a rosin ester tackifier with an acid number of less than 25.

In one embodiment, the tackifier is selected from the following:
a) a hydrocarbon tackifier that has a cloud point (DACP) temperature greater than, or equal to, 20° C.,
c) a terpene tackifier, or
d) a combination thereof.

In one embodiment, the tackifier is selected from the following:
a) a hydrocarbon tackifier that has a cloud point (DACP) temperature greater than, or equal to, 20° C., or
c) a terpene tackifier.

In one embodiment, the tackifier is selected from the following:
b) a rosin ester tackifier with an acid number of less than 25,
c) a terpene tackifier, or
d) a combination thereof.

In one embodiment, the tackifier is selected from the following:
b) a rosin ester tackifier with an acid number of less than 25, or
c) a terpene tackifier.

In one embodiment, the tackifier is selected from the following: a) a hydrocarbon tackifier that has a cloud point (DACP) temperature greater than, or equal to, 20° C.

In one embodiment, the tackifier is selected from the following: b) a rosin ester tackifier with an acid number of less than 25.

In one embodiment, the tackifier is selected from the following: c) a terpene tackifier.

In one embodiment, the tackifier that has a cloud point (DACP) temperature greater than, or equal to, 25° C., further greater than, or equal to, 30° C.

In one embodiment, the tackifier has a cloud point (DACP) temperature from 20° C. to 110° C.

In one embodiment, the tackifier has a cloud point (MMAP) temperature greater than, or equal to, 60° C., further greater than, or equal to, 62° C.

In one embodiment, the tackifier has a cloud point (MMAP) temperature from 60° C. to 110° C.

In one embodiment, the tackifier comprises a C9 ring or ester groups.

Tackifiers include those suitable tackifiers available from Eastman Chemicals, including, but not limited to, PICCOTAC 8595, PICCOTAC 8090E, REGALITE R1090, STAYBELITE ESTER 10E, and EASTOTAC 115R.

A tackifier (Component B) may comprise a combination of two or more embodiments as described herein.

In one embodiment, the anhydride and/or carboxylic acid functionalized ethylene/alpha-olefin interpolymer of Component A is an anhydride and/or carboxylic acid functionalized ethylene/alpha-olefin copolymer. Preferred α-olefins include, but are not limited to, C3-C20 α-olefins, and preferably C3-C10 α-olefins. More preferred α-olefins include propylene, 1-butene, 1-pentene, 1-hexene, 1-heptene and 1-octene, and more preferably include propylene, 1-butene, 1-hexene and 1-octene.

In one embodiment, the anhydride and/or carboxylic acid functionalized ethylene/alpha-olefin interpolymer of Component A has a melt viscosity less than, or equal to, 40,000 cP, further less than, or equal to, 30,000 cP, further less than, or equal to, 20,000 cP, and further less than, or equal to, 15,000 cP, at 350° F. (177° C.). In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, anhydride and/or carboxylic acid functionalized ethylene/alpha-olefin interpolymer of Component A has a melt viscosity greater than, or equal to, 2,000 cP, further greater than, or equal to, 3,000 cP, further greater than, or equal to, 4,000 cP, and further greater than, or equal to, 5,000 cP, at 350° F. (177° C.). In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a melt viscosity from 2,000 cP to 50,000 cP, further from 3,000 cP to 40,000 cP, further from 4,000 cP to 30,000 cP, at 350° F. (177° C.), and further from 5,000 cP to 20,000 cP, at 350° F. (177° C.). In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a molecular weight distribution (Mw/Mn) less than, or equal to, 4.0, further less than, or equal to, 3.5, further less than, or equal to, 3.0. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a molecular weight distribution (Mw/Mn) greater than, or equal to, 1.8, further greater than, or equal to, 2.2, and further greater than, or equal to, 2.5. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a weight average molecular weight (Mw) less than, or equal to, 50,000 g/mole, further less than, or equal to, 40,000 g/mole, further less than, or equal to, 30,000 g/mole. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a weight average molecular weight (Mw) greater than, or equal to, 2,000 g/mole, further greater than, or equal to, 5,000 g/mole, further greater than, or equal to, 10,000 g/mole. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a number average molecular weight (Mn) less than, or equal to, 20,000 g/mole, further less than, or equal to, 15,000 g/mole, further less than, or equal to, 10,000 g/mole. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a number average molecular weight (Mn) greater than, or equal to, 2,000 g/mole, further greater than, or equal to, 5,000 g/mole, further greater than, or equal to, 7,000 g/mole. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a melt index (I2), or calculated melt index (12), greater than, or equal to, 300 g/10 min, further greater than, or equal to, 400 g/10 min, and more further greater than, or equal to, 500 g/10 min. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a melt index (I2), or calculated melt index (12), less than, or equal to, 1500 g/10 min, further less than, or equal to, 1200 g/10 min, and more further less than, or equal to, 1000 g/10 min. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A comprises greater than, or equal to, 0.5 weight percent, further greater than, or equal to, 0.7 weight percent, further greater than, or equal to, 0.8 weight percent, further greater than, or equal to, 0.9 weight percent, and further greater than, or equal to, 1.0 weight percent of the anhydride and/or carboxylic acid functionality, based on the weight of the polymer. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A comprises from 0.9 to 1.5 weight percent, further from 0.9 to 1.4 weight percent, further from 0.9 to 1.3 weight percent of the anhydride and/or carboxylic acid functionality, based on the weight of the polymer. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a percent crystallinity of less than, or equal to, 40 percent, further less than, or equal to, 35 percent, further less than, or equal to, 30 percent, further less than, or equal to, 25 percent, and further less than, or equal to, 20 percent, as determined by DSC. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a percent crystallinity of greater than, or equal to, 2 percent, further greater than, or equal to, 5 percent, and further greater than, or equal to, 10 percent, as determined by DSC. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a density greater than, or equal to, 0.850 g/cc, further greater than, or equal to, 0.855 g/cc, add further greater than, or equal to, 0.860 g/cc. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a density less than, or equal to, 0.900 g/cc, further less than, or equal to, 0.895 g/cc, and further less than, or equal to, 0.890 g/cc. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a density from 0.855 g/cm³ to 0.900 g/cm³, further from 0.860 g/cm³ to 0.895 g/cm³, and further from 0.865 g/cm³ to 0.890 g/cm³. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

In one embodiment, the anhydride and/or carboxylic acid functionalized ethylene/alpha-olefin interpolymer of Component A has a density from 0.860 g/cm³ to 0.890 g/cm³, further from 0.865 g/cm³ to 0.885 g/cm³, and further from 0.870 g/cm³ to 0.880 g/cm³. In a further embodiment, the anhydride and/or carboxylic acid functionalized ethylene/alpha-olefin interpolymer is an anhydride and/or carboxylic acid functionalized ethylene/α-olefin copolymer. Examples of suitable α-olefins are discussed above.

Suitable functionalized copolymers include MAH-grafted copolymers (for example, AFFINITY GA 1000R Polyolefin Plastomer, available from The Dow Chemical Company).

In one embodiment, the composition comprises from 20 to 60 weight percent, and further from 30 to 50 weight percent of Component A, based on the weight of the composition.

In one embodiment, the composition comprises from 20 to 50 weight percent, and further from 30 to 40 weight percent of Component B, based on the weight of the composition.

In one embodiment, the anhydride and/or carboxylic acid functionalized ethylene/alpha-olefin interpolymer (Component A), or copolymer, is formed from an ethylene/alpha-olefin interpolymer (base polymer), or copolymer (base polymer). Examples of suitable α-olefins are discussed above.

An anhydride and/or carboxylic acid functionalized ethylene/alpha-olefin interpolymer (Component A) may comprise a combination of two or more embodiments as described herein.

An anhydride and/or carboxylic acid functionalized ethylene/alpha-olefin copolymer (Component A) may comprise a combination of two or more embodiments as described herein.

In one embodiment, the composition further comprises Component C) an ethylene/alpha-olefin interpolymer, and further an ethylene/alpha-olefin copolymer. Preferred α-olefins include, but are not limited to, C3-C20 α-olefins, and preferably C3-C10 α-olefins. More preferred α-olefins include propylene, 1-butene, 1-pentene, 1-hexene, 1-heptene and 1-octene, and more preferably include propylene, 1-butene, 1-hexene and 1-octene.

In one embodiment, the composition comprises from 10 to 60 weight percent, and further from 10 to 40 weight percent, and further from 10 to 30 weight percent of a wax.

Waxes include, but are not limited to, paraffin waxes, microcrystalline waxes, high density, low molecular weight polyethylene waxes, polypropylene waxes, thermally degraded waxes, by-product polyethylene waxes, Fischer-Tropsch waxes, oxidized Fischer-Tropsch waxes, and functionalized waxes, such as hydroxy stearamide waxes and fatty amide waxes. It is common in the art to use the terminology “synthetic high melting point waxes” to include high density, low molecular weight polyethylene waxes, by-product polyethylene waxes and Fischer-Tropsch waxes. Other waxes also include those described in U.S. Pat. Nos. 6,335,410; 6,054,544 and 6,723,810; which are all incorporated herein by reference. Preferred waxes include, but are not limited to, SASOL waxes (e.g., SASOLWAX H1 from Sasol Wax Company), and Fischer-Tropsch waxes.

In one embodiment, the composition has a melt viscosity at 177° C., from 500 to 10000 cP, further from 600 to 7000 cP, and further from 700 to 5000 cP.

An inventive composition may comprise a combination of two or more embodiments described herein.

The anhydride and/or carboxylic acid functionalized ethylene/alpha-olefin interpolymer of Component A may comprise a combination of two or more embodiments described herein.

The tackifier of Component B may comprise a combination of two or more embodiments described herein.

The invention also provides an article comprising an inventive composition as described herein.

In one embodiment, the article further comprises a substrate. In a further embodiment, the substrate is selected from the group consisting of the following: a coated substrate, a recycled paper, and combinations thereof.

In one embodiment, the substrate is selected from the group consisting of the following: wax coated Kraft or carton, polyethylene coated Kraft or carton, BOPP film laminated Kraft or carton, polypropylene (PP) film laminated Kraft or carton, PET film laminated Kraft or carton, clay coated Kraft or carton, lacquer coated Kraft or carton, and combinations thereof.

An inventive article may comprise a combination of two or more embodiments as described herein.

### Ethylene/α-Olefin Interpolymers (Based Polymers for Component A)

In one embodiment, the base polymer used to form the anhydride and/or carboxylic acid functionalized ethylene/α-olefin interpolymer is an ethylene/α-olefin interpolymer.

In one embodiment, the ethylene/α-olefin interpolymer, is an ethylene/α-olefin copolymer. Preferred α-olefins include, but are not limited to, C3-C20 α-olefins, and further C3-C10 α-olefins. More preferred α-olefins include propylene, 1-butene, 1-pentene, 1-hexene, 1-heptene and 1-octene, and more further include propylene, 1-butene, 1-hexene and 1-octene.

In one embodiment, the ethylene/α-olefin interpolymer has a melt viscosity less than, or equal to, 50,000 cP, further less than, or equal to, 40,000 cP, and further less than, or equal to, 30,000 cP, at 350° F. (177° C.). In a further embodiment, the ethylene/α-olefin interpolymer is an ethylene/α-olefin copolymer. Examples of suitable α-olefins are discussed above. In one embodiment, ethylene/α-olefin interpolymer has a melt viscosity greater than, or equal to, 2,000 cP, further greater than, or equal to, 4,000 cP, more further greater than, or equal to, 5,000 cP, at 350° F. (177° C.). In a further embodiment, the ethylene/α-olefin interpolymer is an ethylene/α-olefin copolymer. Examples of suitable α-olefins are discussed above.

In one embodiment, the ethylene/α-olefin interpolymer has a melt viscosity from 2,000 cP to 20,000 cP, further from 4,000 cP to 16,000 cP, and further from 5,000 cP to 10,000 cP, at 350° F. (177° C.). In a further embodiment, the ethylene/α-olefin interpolymer is an ethylene/α-olefin copolymer. Examples of suitable α-olefins are discussed above.

In one embodiment, the ethylene/α-olefin interpolymer has a molecular weight distribution (Mw/Mn) less than, or equal to, 5.0, and further less than, or equal to, 4.0, and more further less than, or equal to, 3.0. Further the ethylene/α-olefin interpolymers have a molecular weight distribution from 1.1 to 3.5, and further from 1.1 to 3.0, and more further from 1.1 to 2.5. In a further embodiment, the ethylene/α-olefin interpolymer is an ethylene/α-olefin copolymer. Examples of suitable α-olefins are discussed above.

In one embodiment, the ethylene/α-olefin interpolymer has a melt index (I2 or MI), or calculated melt index (I2), greater than, or equal to, 500 g/10 min, further greater than, or equal to, 800 g/10 min, and more further greater than, or equal to, 1000 g/10 min. In a further embodiment, the ethylene/α-olefin interpolymer is an ethylene/α-olefin copolymer. Examples of suitable α-olefins are discussed above.

In one embodiment, the ethylene/α-olefin interpolymer has a percent crystallinity of less than, or equal to, 40 percent, further less than, or equal to, 30 percent, and more further less than, or equal to, 20 percent, as determined by DSC. In a further embodiment, the ethylene/α-olefin interpolymer is an ethylene/α-olefin copolymer. Examples of suitable α-olefins are discussed above.

In one embodiment, the ethylene/α-olefin interpolymer has a percent crystallinity of greater than, or equal to, 2 percent, further greater than, or equal to, 5 percent, and more further greater than, or equal to, 10 percent, as determined by DSC. In a further embodiment, the ethylene/α-olefin interpolymer is an ethylene/α-olefin copolymer. Examples of suitable α-olefins are discussed above.

In one embodiment, the ethylene/α-olefin interpolymer has a percent crystallinity from 2 to 30 percent, further from 5 to 25 percent, and more further from 10 to 20 percent, as determined by DSC. In a further embodiment, the ethylene/α-olefin interpolymer is an ethylene/α-olefin copolymer. Examples of suitable α-olefins are discussed above. In one embodiment, the ethylene/α-olefin interpolymer has a percent crystallinity from 10 to 27 percent, further from 15 to 25 percent, and more further from 18 to 23 percent, as determined by DSC. In a further embodiment, the ethylene/α-olefin interpolymer is an ethylene/α-olefin copolymer. Examples of suitable α-olefins are discussed above.

In one embodiment, the ethylene/α-olefin interpolymer has a density greater than, or equal to, 0.855 g/cc, further greater than, or equal to, 0.860 g/cc, more further greater than, or equal to, 0.865 g/cc. In a further embodiment, the ethylene/α-olefin interpolymer is an ethylene/α-olefin copolymer. Examples of suitable α-olefins are discussed above.

In one embodiment, the ethylene/α-olefin interpolymer has a density less than, or equal to, 0.900 g/cc, further less than, or equal to, 0.895 g/cc, more further less than, or equal to, 0.890 g/cc. In a further embodiment, the ethylene/α-olefin interpolymer is an ethylene/α-olefin copolymer. Examples of suitable α-olefins are discussed above.

In one embodiment, the ethylene/α-olefin interpolymer has a density from 0.855 g/cm³ to 0.900 g/cm³, and further from 0.860 g/cm³ to 0.895 g/cm³, and more further from 0.865 g/cm³ to 0.890 g/cm³. In a further embodiment, the ethylene/α-olefin interpolymer is an ethylene/α-olefin copolymer. Examples of suitable α-olefins are discussed above.

In one embodiment, the ethylene/α-olefin interpolymer has a density from 0.860 g/cm³ to 0.890 g/cm³, and further from 0.865 g/cm³ to 0.885 g/cm³, and more further from 0.870 g/cm³ to 0.880 g/cm³. In a further embodiment, the ethylene/α-olefin interpolymer is an ethylene/α-olefin copolymer. Examples of suitable α-olefins are discussed above.

Some examples of ethylene/α-olefin copolymers include suitable AFFINITY GA Polyolefin Plastomers, available from The Dow Chemical Company, and suitable LICOCENE Performance Polymers from Clariant. Other examples of ethylene/α-olefin polymers suitable for the invention include the ultra low molecular weight ethylene polymers described in U.S. Pat. Nos. 6,335,410, 6,054,544 and 6,723,810, each fully incorporated herein by reference.

In one embodiment, the ethylene/α-olefin interpolymer is a homogeneously branched linear interpolymer, and further a copolymer, or a homogeneous branched substantially linear interpolymer, and further a copolymer. Examples of suitable α-olefins are discussed above.

In one embodiment, the ethylene/α-olefin interpolymer is a homogeneously branched linear interpolymer, and further a copolymer. Examples of suitable α-olefins are discussed above.

In one embodiment, the ethylene/α-olefin interpolymer is a homogeneous branched substantially linear interpolymer, and further a copolymer. Examples of suitable α-olefins are discussed above.

The terms “homogeneous” and “homogeneously-branched” are used in reference to an ethylene/α-olefin interpolymer, in which the α-olefin comonomer is randomly distributed within a given polymer molecule, and all of the polymer molecules have the same or substantially the same comonomer-to-ethylene ratio.

The homogeneously branched linear ethylene interpolymers are ethylene polymers, which lack long chain branching (or lack measureable amounts of long chain branching), but do have short chain branches, derived from the comonomer polymerized into the interpolymer, and which are homogeneously distributed, both within the same polymer chain, and between different polymer chains. These ethylene/α-olefin interpolymers have a linear polymer backbone, no measurable long chain branching, and a narrow molecular weight distribution. This class of polymers is disclosed, for example, by Elston in U.S. Pat. No. 3,645,992, and subsequent processes to produce such polymers, using bis-metallocene catalysts, have been developed, as shown, for example, in EP 0 129 368; EP 0 260 999; U.S. Pat. No. 4,701,432; U.S. Pat. No. 4,937,301; U.S. Pat. No. 4,935,397; U.S. Pat. No. 5,055,438; and WO 90/07526; each incorporated herein by reference. As discussed, the homogeneously branched linear ethylene interpolymers lack long chain branching, just as is the case for the linear low density polyethylene polymers or linear high density polyethylene polymers. Commercial examples of homogeneously branched linear ethylene/α-olefin interpolymers include TAFMER polymers from the Mitsui Chemical Company, and EXACT and EXCEED polymers from ExxonMobil Chemical Company.

The homogeneously branched substantially linear ethylene/α-olefin interpolymers are described in U.S. Pat. Nos. 5,272,236; 5,278,272; 6,054,544; 6,335,410 and 6,723,810; each incorporated herein by reference. The substantially linear ethylene/α-olefin interpolymers have long chain branching. The long chain branches have the same comonomer distribution as the polymer backbone, and can have about the same length as the length of the polymer backbone. “Substantially linear,” typically, is in reference to a polymer that is substituted, on average, with “0.01 long chain branches per 1000 carbons” to “3 long chain branches per 1000 carbons.” The length of a long chain branch is longer than the carbon length of a short chain branch, formed from the incorporation of one comonomer into the polymer backbone.

Some polymers may be substituted with 0.01 long chain branches per 1000 total carbons to 3 long chain branch per 1000 total carbons, further from 0.01 long chain branches per 1000 total carbons to 2 long chain branch per 1000 total carbons, and further from 0.01 long chain branches per 1000 total carbons to 1 long chain branch per 1000 total carbons.

The substantially linear ethylene/α-olefin interpolymers form a unique class of homogeneously branched ethylene polymers. They differ substantially from the well-known class of conventional, homogeneously branched linear ethylene/α-olefin interpolymers, as discussed above, and, moreover, they are not in the same class as conventional heterogeneous “Ziegler-Natta catalyst polymerized” linear ethylene polymers (for example, ultra low density polyethylene (ULDPE), linear low density polyethylene (LLDPE) or high density polyethylene (HDPE), made, for example, using the technique disclosed by Anderson et al., in U.S. Pat. No. 4,076,698); nor are they in the same class as high pressure, free-radical initiated, highly branched polyethylenes, such as, for example, low density polyethylene (LDPE), ethylene-acrylic acid (EAA) copolymers and ethylene vinyl acetate (EVA) copolymers.

The homogeneously branched, substantially linear ethylene/α-olefin interpolymers useful in the invention have excellent processability, even though they have a relatively narrow molecular weight distribution. Surprisingly, the melt flow ratio (I10/I2), according to ASTM D 1238, of the substantially linear ethylene interpolymers can be varied widely, and essentially independently of the molecular weight distribution (Mw/Mn or MWD). This surprising behavior is contrary to conventional homogeneously branched linear ethylene interpolymers, such as those described, for example, by Elston in U.S. Pat. No. 3,645,992, and heterogeneously branched, conventional “Ziegler-Natta polymerized,” linear polyethylene interpolymers, such as those described, for example, by Anderson et al., in U.S. Pat. No. 4,076,698. Unlike substantially linear ethylene interpolymers, linear ethylene interpolymers (whether homogeneously or heterogeneously branched) have rheological properties, such that, as the molecular weight distribution increases, the 110/12 value also increases.

Long chain branching can be determined by using 13C Nuclear Magnetic Resonance (NMR) spectroscopy, and can be quantified using the method of Randall (Rev. Macromol. Chem. Phys., C29 (2 &3), 1989, p. 285-297), the disclosure of which is incorporated herein by reference. Two other methods are Gel Permeation Chromatography, coupled with a Low Angle Laser Light Scattering detector (GPCLALLS), and Gel Permeation Chromatography, coupled with a Differential Viscometer detector (GPC-DV). The use of these techniques for long chain branch detection, and the underlying theories, have been well documented in the literature. See, for example, Zimm, B. H. and Stockmayer, W. H., J. Chem. Phys., 17, 1301 (1949), and Rudin, A., Modern Methods of Polymer Characterization, John Wiley & Sons, New York (1991) pp. 103-112.

In contrast to “substantially linear ethylene polymer,” “linear ethylene polymer” means that the polymer lacks measurable or demonstrable long chain branches, that is, the polymer is substituted with an average of less than 0.01 long chain branch per 1000 carbons.

The ethylene/α-olefin interpolymer may comprise a combination of two or more embodiments as described herein.

The ethylene/α-olefin copolymer may comprise a combination of two or more embodiments as described herein.

### Additives and Applications

An inventive composition may comprise one or more additives. Additives include, but are not limited to, stabilizers, antistatic agents, pigments and dyes, nucleating agents, fillers, slip agents, fire retardants, plasticizers, processing aids, lubricants, stabilizers, smoke inhibitors, viscosity control agents and anti-blocking agents. The inventive compositions may also contain one or more thermoplastic polymers. Typically polymers and resins used in the invention are treated with one or more stabilizers, for example, antioxidants, such as IRGANOX 1010, IRGANOX 1076, and IRGAFOS 168, now supplied by BASF. Polymers are typically treated with one or more stabilizers before an extrusion or other melt processes.

The inventive compositions may further comprise an oil. Oils are typically employed to reduce the viscosity of the adhesive. When employed, oils will be typically present in an amount less than 50, preferably less than 40, and more preferably less than 35 weight percent, based on the weight of the adhesive formulation. Exemplary classes of oils include, but are not limited to, white mineral oil (such as KAYDOL oil available from Witco), and SHELLFLEX 371 naphthenic oil (available from Shell Oil Company) and CALSOL 5550 (napthenic oil from Calumet Lubricants). In one embodiment, the composition comprises from 2 to 50 weight percent, further from 5 to 40 weight percent, further from 10 to 30 weight percent of an oil, based on the weight of the composition.

The inventive compositions may be prepared by standard melt blending procedures. In particular, the anhydride and/or carboxylic acid functionalized ethylene/alpha-olefin interpolymer (for example, a maleic anhydride-grafted interpolymer) or blend containing the same, tackifier(s) and other components may be melt blended, until a homogeneous mix is obtained. Any mixing method producing a homogeneous blend, without degrading the adhesive components, is satisfactory, such as a vessel equipped with a stirrer, and an optional heating mechanism. The adhesives can be provided in forms, such as pellets, pillows, chiclets, drages or any other desired configurations.

The inventive compositions may also be used in a variety of application, including, but not limited to, case and carton sealing, automotive, graphic arts, nonwovens, panel assembly, high performance tapes, contact hot melt adhesives, paperboard coatings, inks, personal care and cosmetic products, sealants, color and additive concentrates, carpet-tape adhesives, woodworking adhesives, and profile wrap adhesives.

### DEFINITIONS

Unless stated to the contrary, all test methods are current as of the filing date of this disclosure.

The term “composition,” as used herein, includes a mixture of materials which comprise the composition, as well as reaction products and decomposition products formed from the materials of the composition.

The term “polymer,” as used herein, refers to a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities, for example, catalyst residues, may be incorporated into and/or within the polymer.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The term, “olefin-based polymer,” as used herein, refers to a polymer that comprises, in polymerized form, a majority amount of olefin monomer, for example ethylene or propylene (based on the weight of the polymer), and optionally may comprise one or more comonomers.

The term, “propylene-based polymer,” as used herein, refers to a polymer that comprises, in polymerized form, a majority amount of propylene monomer (based on the weight of the polymer), and optionally may comprise one or more comonomers.

The term, “ethylene-based polymer,” as used herein, refers to a polymer that comprises, in polymerized form, a majority amount of ethylene monomer (based on the weight of the polymer), and optionally may comprise one or more comonomers.

The term, “ethylene/α-olefin interpolymer,” as used herein, refers to an interpolymer that comprises, in polymerized form, a majority amount of ethylene monomer (based on the weight of the interpolymer), and at least one α-olefin.

The term, “ethylene/α-olefin copolymer,” as used herein, refers to a copolymer that comprises, in polymerized form, a majority amount of ethylene monomer (based on the weight of the copolymer), and an α-olefin, as the only two monomer types.

The term “an anhydride and/or carboxylic acid functionalized ethylene/alphα-olefin interpolymer (or copolymer),” as used herein, refers to an ethylene/alphα-olefin interpolymer (or copolymer) that comprises anhydride groups and/or carboxylic acid groups covalently bonded to the interpolymer (or copolymer). In one embodiment, the anhydride groups and/or carboxylic acid groups are grafted onto the interpolymer (or copolymer).

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

### Test Methods

### Melt Viscosity

Melt viscosity is measured in accordance with ASTM D 3236 (350° F.), using a Brookfield Digital Viscometer (Model DV-III, version 3), and disposable aluminum sample chambers. The spindle used, in general, is a SC-31 hot-melt spindle, suitable for measuring viscosities in the range from 10 to 100,000 centipoise. The sample is poured into the chamber, which is, in turn, inserted into a Brookfield Thermosel, and locked into place. The sample chamber has a notch on the bottom that fits the bottom of the Brookfield Thermosel, to ensure that the chamber is not allowed to turn when the spindle is inserted and spinning. The sample (approximately 8-10 grams of resin) is heated to the required temperature, until the melted sample is about one inch below the top of the sample chamber. The viscometer apparatus is lowered, and the spindle submerged into the sample chamber. Lowering is continued, until the brackets on the viscometer align on the Thermosel. The viscometer is turned on, and set to operate at a shear rate which leads to a torque reading in the range of 40 to 60 percent of the total torque capacity, based on the rpm output of the viscometer. Readings are taken every minute for about 15 minutes, or until the values stabilize, at which point, a final reading is recorded.

### Melt Index

Melt index (I2, or MI) of an ethylene-based polymer is measured in accordance with ASTM D-1238, condition 190° C./2.16 kg. For high 12 polymers (12 greater than, or equal to, 200 g/mole, melt index is preferably calculated from Brookfield viscosity as described in U.S. Pat. Nos. 6,335,410; 6,054,544; 6,723,810. I2(190° C./2.16 kg)=3.6126[10^{(log(η)-6.6928)/-1.1363}]−9.3185, where η=melt viscosity, in cP, at 350° F.

### Percent Fiber Tear

The percentage of fiber tear of each adhesive sample was evaluated on regular cardboard, and hard to bond substrates, at three different temperatures: room temperature, −17° C. and 60° C. The fiber tear results on the different substrates were recorded. The adhesive was heated to 350° F./177° C., and was applied on the substrate cut into “1 in×3 in (25 mm×76 mm)” rectangular sheets. The adhesive to be tested was applied, running lengthwise, as about a “5 mm/0.2 in” wide strip, and was drawn down with a spatula or hot melt applicator. Then a second strip was applied within two seconds, and held, with moderate hand pressure, for five seconds, to laminate.

The bonds, conditioned for 24 hours at room temperature and 54 percent RH, and then the respective bonds pulled apart at the test temperatures of room temperature, −17° C. or 60° C. Each bond was tested immediately, after the conditioning period ended. The bond was torn by inserting the blade of a spatula under one corner to fold up the corner. The bond was then placed on a horizontal surface, with the side with the folded corner faced up. With the laminate held as near as possible to the source of heating or cooling, in order to maintain the conditioning temperature, the folded corner is manually pulled as rapidly, as possible, at roughly a 45 to 90 degree angle, relative to each sheet's lengthwise axis, to tear the adhesive bond. The percent of torn fiber was estimated (fiber tear or FT) in 25 percent increments; that is, 0 percent, 25 percent, 50 percent, 75 percent and 100 percent. Unless otherwise stated, the FT test is normally repeated on five replicate samples, and the average of these five runs reported.

### Gel Permeation Chromatography

The average molecular weights and molecular weight distributions for ethylene-base polymers are determined with a chromatographic system, consisting of either a Polymer Laboratories Model PL-210 or a Polymer Laboratories Model PL-220. The column and carousel compartments are operated at 140° C. for ethylene-based polymers. The columns are three Polymer Laboratories 10-micron, Mixed-B columns. The solvent is 1,2,4-trichloro-benzene. The samples are prepared at a concentration of “0.1 gram of polymer” in “50 milliliters” of solvent. The solvent used to prepare the samples contains “200 ppm of butylated hydroxytoluene (BHT).” Samples are prepared by agitating lightly for two hours at 160° C. The injection volume is “100 microliters,” and the flow rate is 1.0 milliliters/minute. Calibration of the GPC column set is performed with narrow molecular weight distribution polystyrene standards, purchased from Polymer Laboratories (UK). The polystyrene standard peak molecular weights are converted to polyethylene molecular weights using the following equation (as described in Williams and Ward, J. Polym. Sci., Polym. Let., 6, 621 (1968)):

M_{polyethylene}=A×(M_{polystyrene})^{B},

where M is the molecular weight, A has a value of 0.4315 and B is equal to 1.0. Polyethylene equivalent molecular weight calculations were performed using VISCOTEK TriSEC software Version 3.0. The molecular weights for polypropylene-based polymers can be determined using Mark-Houwink ratios according to ASTM D6474.9714-1, where, for polystyrene a=0.702 and log K=−3.9, and for polypropylene, a=0.725 and log K=−3.721. For polypropylene-based samples, the column and carousel compartments are operated at 160° C.

### Differential Scanning Calorimetry

Differential Scanning calorimetry (DSC) is used to measure crystallinity in polyethylene (PE) based samples and polypropylene (PP) based samples. About five to eight milligrams of sample is weighed and placed in a DSC pan. The lid is crimped on the pan to ensure a closed atmosphere. The sample pan is placed in a DSC cell, and then heated, at a rate of approximately 10° C./min, to a temperature of 180° C. for PE (230° C. for PP). The sample is kept at this temperature for three minutes. Then the sample is cooled at a rate of 10° C./min to −60° C. for PE (−40° C. for PP), and kept isothermally at that temperature for three minutes. The sample is next heated at a rate of 10° C./min, until complete melting (second heat). The percent crystallinity is calculated by dividing the heat of fusion (H_{f}), determined from the second heat curve, by a theoretical heat of fusion of 292 J/g for PE (165 J/g, for PP), and multiplying this quantity by 100 (e.g., for PE, % cryst.=(H_{f}/292 J/g)×100; and for PP, % cryst.=(H_{f}/165 J/g)×100).

Unless otherwise stated, melting point(s) (Tₘ) of each polymer is determined from the second heat curve obtained from DSC, as described above. The crystallization temperature (T_{c}) is measured from the first cooling curve.

### Density

Samples for density measurement are prepared according to ASTM D 1928. Polymer samples are pressed at 190° C. and 30,000 psi (207 MPa) for three minutes, and then at 21° C. and 30,000 psi (207 MPa) for one minute. Measurements are made within one hour of sample pressing using ASTM D792, Method B.

### Fourier Transform Infrared Spectroscopy (FTIR) Analysis—Maleic Anhydride Content.

The concentration of maleic anhydride is determined by the ratio of peak heights of the maleic anhydride at wave number 1791 cm⁻¹ to the polymer reference peak, which, in case of polyethylene, is at wave number 2019 cm⁻¹. Maleic anhydride content is calculated by multiplying this ratio with the appropriate calibration constant. The equation used for maleic grafted polyolefins (with reference peak for polyethylene) has the following form, as shown in Equation 1.

MAH(wt %)=A*{[FTIR PeakArea@1791 cm-1][FTIR PeakArea 2019 cm-1]+B*[FTIR PeakArea@1712 cm-1]/[FTIR_PeakArea@2019 cm-1]} (Eqn. 1)

The calibration constant A can be determined using C13 NMR standards. The actual calibration constant may differ slightly depending on the instrument and polymer. The second component at wave number 1712 cm⁻¹ accounts for the presence of maleic acid, which is negligible for freshly grafted material. Over time however, maleic anhydride is readily converted to maleic acid in the presence of moisture. Depending on surface area, significant hydrolysis can occur in just a few days under ambient conditions. The acid has a distinct peak at wave number 1712 cm⁻¹. The constant B in Equation 1 is a correction for the difference in extinction coefficients between the anhydride and acid groups.

The sample preparation procedure begins by making a pressing, typically 0.05 to 0.15 millimeters in thickness, in a heated press, between two protective films, at 150-180° C. for one hour. MYLAR and TEFLON are suitable protective films to protect the sample from the platens. Aluminum foil must never be used (maleic anhydride reacts with aluminum). Platens should be under pressure (˜10 ton) for about five minutes. The sample is allowed to cool to room temperature, placed in an appropriate sample holder, and then scanned in the FTIR. A background scan should be run before each sample scan, or as needed. The precision of the test is good, with an inherent variability of less than ±5%. Samples should be stored with desiccant to prevent excessive hydrolysis. Moisture content in the product has been measured as high as 0.1 weight percent. The conversion of anhydride to acid however is reversible with temperature, but may take up to one week for complete conversion. The reversion is best performed in a vacuum oven at 150° C.; a good vacuum (near 30 inches Hg) is required. If the vacuum is less than adequate, the sample tends to oxidize, resulting in an infrared peak at approximately 1740 cm⁻¹, which will cause the values for the graft level to be too low. Maleic anhydride and acid are represented by peaks at about 1791 and 1712 cm⁻¹, respectively.

### Measurement of Cloud Point of Adhesive Composition

FIG. 1 shows a turbidity fractionation analyzer (TFA) used in the experiments to measure the turbidity of polymer solutions. The turbidity fractionation analyzer consisted of a laser diode (630 nm, 4.5 mW), an intensity detector (Si photo diode), and an aluminum cell holder that is capable of controlled heating and cooling. A 45° reference detector was also included to monitor any changes in source intensity. This instrument monitored the turbidity of a solution with changes in temperature. Under constant stirring, the excitation voltage of the detector measured the laser light that passed through the, above mentioned, solution and cell block.

For these cloud point experiments, cloud point formulations were prepared by measuring 25 g of tackifier and 25 g of polymer into adhesive mixing cans. The cans were then preheated in an oven at 200° C. for 30-45 minutes, and then mixed in a can mixing apparatus at 200° C. for 45 minutes.

The samples for cloud point determination were placed into the TFA cell block, and stabilized for 30 minutes at 160° C., and then cooled to 30° C. at a rate of about 1° C./min. During cooling, the detectors' response to the laser light passing through the center of the measurement vial was recorded via LABView Software from National Instruments. Once completed, reduction of the data was as follows:
1) The detector response profile was normalized by the initial voltage measured (i.e. 100% transmittance of the laser light, when the sample was completely dissolved in solution). To account for any fluctuations in the laser source intensity, the detector response is the ratio of the transmittance voltage and the reference detector voltage.
2) This normalized curve was considered the turbidity curve. A decrease in detector response indicates an increase in turbidity of the polymer solution. Refer to Equation 1.

$$Turbidity ( Temp ) = \frac{Initial Voltage - Measured Voltage}{Initial Voltage} . \qquad Eqn . 1$$

3) Afterwards, a Savitzky-Golay smoothing algorithm [Press W H., Teukolosky S A, Vetterling W A, Flannery B P. Numerical Recipes in C++ The Art of Scientific Computing, 2nd Ed. New York: Cambridge Press, 2002 (pp. 655-656)] was applied to the turbidity data to smooth the turbidity data and calculate the first derivative.
4) The data was then plotted as turbidity versus temperature or as the derivative (dTurbidity/dTemp) versus temperature.
5) The cloud point was recorded as the highest value (peak) of the derivative (dTurbidity//dTemp) versus temperature.
   See Li Pi Shan, C.; deGroot, W. A.; Hazlitt, L. G.; Gillespie, D.; Polymer, 46, 11755-11767 (2005); incorporated herein by reference.

### Measurement of Cloud Point—DACP of Tackifier

The DACP (Di-Acetone Alcohol Cloud Point) can be determined using a modified ASTM D-611-82 procedure. For this method, the solvent mixture used in the standard test procedure is substituted by xylene and di-acetone alcohol in a 1:1 volume blend. The procedure uses resin/xylene/di-acetone alcohol in a ratio 1/1/1 (5 g/5 ml/5 ml), and the cloud point is determined by cooling a heated, clear blend of the three components, until a complete turbidity just occurs. See also EP0802251B1.

### Measurement of Cloud Point—MMAP of Tackifier

The MMAP (Mixed Methylcyclohexane Cloud point) can be determined using a modified ASTM D-611-82 procedure. The methylcyclohexane is substituted for the heptane used in the standard test procedure. The procedure uses resin/aniline/methylcyclohexane in a ratio 1/2/1 (5 g/10 ml/5 ml), and the cloud point is determined by cooling a heated, clear blend of the three components, until a complete turbidity just occurs. See also EP0802251B1.

### Acid Number

Acid number can be determined by ASTM D664-11a—Standard Test Method for Acid Number of Petroleum Products by Potentiometric Titration. A potentiometric titration is carried out by the neutralization using KOH, and reported as the number given in mg of KOH necessary to neutralize one gram of the acid.

The polymers, compositions and processes of this invention, and their use, are more fully described by the following examples. The following examples are provided for the purpose of illustrating the invention, and are not to be construed as limiting the scope of the invention.

### EXPERIMENTAL

The polymers used in this study are listed in Table 1. Tackifiers shown below in Table 2.

TABLE 1
Polymers used in the Experimental Adhesive (HMA) Formulations

| | Calculated | Melt | | | | |
|---|---|---|---|---|---|---|
| | I2* at | Viscosity | | | | |
| | 190° C. | at | | Mw^{a} | Mn^{a} | |
| | (g/10 | 177° C. | Density | (g/ | (g/ | Mw/ |
| Polymer | min) | (cP) | (g/cm3) | mol) | mol) | Mn^{a} |
| AFFINITY | 1000 | 8200 | 0.870 | 20000 | 9523 | 2.1 |
| GA 1900^{b} | | | | | | |
| AFFINITY | 660 | 13000 | 0.878 | 26127 | 8585 | 2.7 |
| GA 1000R^{b} | | | | | | |

^{a}GPC results.
^{b}Available from The Dow Chemical Company. AFFINITY GA 1900 is an ethylene/octene copolymer. AFFINITY GA 1000R is an MAH-g-ethylene/octene copolymer.
*Melt index may be calculated from the following equation (See U.S. Pat. No. 6,335,410): I2 (190° C./2.16 kg) = 3.6126[10^{(log(}η^{)-6.6928)/-1.1363}] − 9.3185, where η = melt viscosity, in cP, at 350° F. (177° C.).

TABLE 2
Tackifiers*

| | Softening | | Cloud Point, ° C. | |
|---|---|---|---|---|
| Tackifier* | Point (° C.) | M_{Z} | (MMAP, DACP) | Description |
| PICCOTAC 8595 | 95 | 3200 | 81, 38** | Aromatic modified |
| | | | | hydrocarbon resin |
| PICCOTAC 8090E | 92 | 3800 | 64, 20** | Aromatic modified |
| | | | | hydrocarbon resin |
| REGALREZ 6108 | 108 | 2300 | 54, 15** | Partially hydrogenated |
| | | | | hydrocarbon resin |
| REGALITE R7100 | 102 | 1500 | 62, 14** | Partially hydrogenated |
| | | | | hydrocarbon resin |
| REGALITE S5100 | 100 | 1400 | 57, 8** | Partially hydrogenated |
| | | | | hydrocarbon resin |
| REGALITE R1090 | 88 | 1100 | 74, 39** | Fully hydrogenated |
| | | | | hydrocarbon resin |
| STAYBELITE | 86 | | <−20° C.*** | Partially hydrogenated |
| ESTER 10E | | | | gum rosin |
| KRISTALEX 3085 | 85 | 1900 | 1, <−50 | Hydrocarbon resin |
| EASTOTAC 115R | 115 | 2300 | 78, 60 | Tackifier resin |

*Each tackifier is available from Eastman Chemicals.
**EASTOFLEX Amorphous Polyolefins, 12/09 (product brochure from Eastman).
***A rosin resin typically has a DACP <−20° C. (see www.pstc.org/files/public/Donker.pdf); acid number less than 25.

### Compatibility Study

Each formulation used for this study contained 25 grams polymer (AFFINITY GA 1900 or AFFINITY GA 1000R) and 25 grams of tackifier. The cloud point of each formulation was examined using the test equipment shown in FIG. 1. Results are shown in Table 3 below.

TABLE 3
Cloud Points

| | Cloud Point (° C.) | | |
|---|---|---|---|
| | AFFINITY | AFFINITY | |
| Tackifier | GA 1900 | GA 1000R | ΔCloud Point (° C.) |
| PICCOTAC 8595 | 49.5 | 41.1 | 8.4 |
| PICCOTAC 8090E | 133.5 | 112.9 | 20.6 |
| REGALREZ 6108 | >180 | >180 | — |
| REGALITE R7100 | >180 | >180 | — |
| REGALITE S5100 | >180 | >180 | — |
| REGALITE R1090 | 143.3 | 99.5 | 43.8 |
| STAYBELITE 10E | 94.5 | 43.5 | 51 |
| KRISTALEX 3085 | >180 | >180 | — |
| EASTOTAC H115 | 25-30 | 25-30 | — |

As seen from Table 3, REGALREZ 6108, REGALITE R7100, REGALITE S5100, and KRISTALEX 3085 were not compatible in either polymer, as shown by the very high cloud point (>180° C.) for these formulations. PICCOTAC 8090E, REGALITE 1090, and STAYBELITE 10E experienced significant cloud point depression in the respective formulations containing the AFFINITY GA 1000R, which indicated a significant improvement compatibility of tackifier and polymer in these formulations. STAYBELITE 10E was incompatible in AFFINITY GA 1900, and compatible in AFFINITY GA 1000R.

### Adhesion Study

The substrates used in this study are listed below.

Substrate 1: uncoated cardboard.
Substrate 2: polyacrylate substrate.
Substrate 3: substrate coated with a paraffinic wax (Tm 73° C.).
Substrate 4: substrate coated with a paraffinic wax (Tm 74° C.).
Substrate 5: polypropylene (Tm 160° C.) coated with a paraffinic wax (Tm 76° C.).
Substrate 6: polypropylene coated substrate.

### Adhesive Formulations

Components for the adhesive compositions were weighed into an aluminum container, and preheated in an oven, at 180° C., for one hour. The components in the container were then mixed in a heated block at 180° C. for 30 minutes, with a “Paravisc style” mixer head at 100 RPM. Each adhesive composition contained the following: polymer (AFFINITY GA 1900 or AFFINITY GA 1000R), wax (SASOLWAX H1, a Fischer-Tropsch wax supplied by Sasol Wax), tackifier resin, and stabilizer (IRGANOX 1010). Adhesive formulations are listed in Table 4 below.

TABLE 4
Adhesive Compositions (Amounts are in wt %)

| | AFFINITY | AFFINITY | EASTOTAC | PICCOTAC | STAYBELITE | SASOL | IRGANOX |
|---|---|---|---|---|---|---|---|
| Ex. | GA1900 | GA1000R | 115R | 8595 | 10E | H1 | 1010 |
| 1C | 35 | | 39.8 | | | 25 | 0.2 |
| 2I | | 35 | 39.8 | | | 25 | 0.2 |
| 3C | 40 | | 34.8 | | | 25 | 0.2 |
| 4I | | 40 | 34.8 | | | 25 | 0.2 |
| 5C | 35 | | | 39.8 | | 25 | 0.2 |
| 6I | | 35 | | 39.8 | | 25 | 0.2 |
| 7C | 40 | | | 34.8 | | 25 | 0.2 |
| 8I | | 40 | | 34.8 | | 25 | 0.2 |
| 9C | 35 | | | | 39.8 | 25 | 0.2 |
| 10I | | 35 | | | 39.8 | 25 | 0.2 |
| 11C | 40 | | | | 34.8 | 25 | 0.2 |
| 12I | | 40 | | | 34.8 | 25 | 0.2 |

Adhesion results (% Fiber Tear) are shown in Tables 5-10 below.

TABLE 5
(Substrate 1)

| | Average Percent Fiber Tears | | |
|---|---|---|---|
| Ex. | −17° C. | RT | 60° C. |
| 3C | 99.6 | 100 | 62.2 |
| 4I | 99.6 | 100 | 67 |
| 7C | 99.6 | 100 | 62.2 |
| 8I | 98.2 | 100 | 58 |
| 11C | 99 | 100 | 51.6 |
| 12I | 100 | 100 | 74.4 |

TABLE 6
(Substrate 2)

| | Average Percent Fiber Tears | | |
|---|---|---|---|
| | −17° C. | RT | 60° C. |
| 3C | 78.3 | 99 | 45 |
| 4I | 90.7 | 70.2 | 61.7 |
| 7C | 39 | 91.6 | 56 |
| 8I | 78 | 50 | 96.3 |
| 11C | 19.3 | 59.6 | 11.3 |
| 12I | 84 | 99.6 | 53.7 |

TABLE 7
(Substrate 3)

| | Average Percent Fiber Tears | | |
|---|---|---|---|
| | −17° C. | RT | 60° C. |
| 3C | 91.4 | 100 | 58.2 |
| 4I | 94.4 | 99.8 | 65 |
| 7C | 77.4 | 98.2 | 60.4 |
| 8I | 98.8 | 99.6 | 90.8 |
| 11C | 84.4 | 99 | 50.4 |
| 12I | 100 | 100 | 66.4 |

TABLE 8
(Substrate 4)

| | Average Percent Fiber Tears | | |
|---|---|---|---|
| | −17° C. | RT | 60° C. |
| 3C | 97.2 | 100 | 54.6 |
| 4I | 97.4 | 100 | 95.2 |
| 7C | 90 | 100 | 84.2 |
| 8I | 98.2 | 100 | 99.6 |
| 11C | 100 | 100 | 53.6 |
| 12I | 100 | 100 | 89 |

TABLE 9
(Substrate 5)

| | Average Percent Fiber Tears | | |
|---|---|---|---|
| | −17° C. | RT | 60° C. |
| 3C | 18 | 78 | 82.6 |
| 4I | 52 | 80 | 97.2 |
| 7C | 57 | 79.4 | 99.4 |
| 8I | 62.6 | 100 | 93.6 |
| 11C | 80 | 92 | 99 |
| 12I | 71 | 100 | 89.8 |

TABLE 10
(Substrate 6)

| | Average Percent Fiber Tears | | |
|---|---|---|---|
| | −17° C. | RT | 60° C. |
| 3C | 86.7 | 99.6 | 64.3 |
| 4I | 100 | 99.6 | 84.3 |
| 7C | 81.7 | 100 | 85.7 |
| 8I | 48.3 | 100 | 96.7 |
| 11C | 43.3 | 100 | 93.3 |
| 12I | 100 | 100 | 54 |

As seen in the above tables, compositions containing the AFFINITY GA1000R (MAH-g) had overall improved adhesive performance on various hard-to-bond substrates, as compared to those compositions containing AFFINITY GA1900.

Compositions containing AFFINITY GA1000R with PICCOTAC 8595 perform significantly better than similar compositions containing AFFINITY GA1900, especially in the high and low temperature ranges. The effects of poor compatibility are evident in the comparative compositions. Compositions containing AFFINITY GA1000R with STAYBELITE 10E perform better than similar compositions containing AFFINITY GA1900, especially in the high and low temperature ranges. Again, the effects of poor compatibility are evident in the comparative compositions. It has been shown that compositions containing AFFINITY GA1000R can markedly improve compatibility with polar tackifiers.

1. A composition comprising the following components:
A) an anhydride and/or carboxylic acid functionalized ethylene/alpha-olefin interpolymer having the following properties:
i) a melt viscosity (177° C.) less than, or equal to, 50,000 cP,
ii) a density from 0.855 to 0.900 g/cc;
B) a tackifier selected from the following:
a) a hydrocarbon tackifier that has a cloud point (DACP) temperature greater than, or equal to, 20° C.,
b) a rosin ester tackifier with an acid number of less than 25,
c) a terpene tackifier, or
d) a combination thereof.

2. The composition of claim 1, wherein the tackifier is selected from the following:
a) a hydrocarbon tackifier that has a cloud point (DACP) temperature greater than, or equal to, 20° C.,
b) a rosin ester tackifier with an acid number of less than 25, or
d) a combination thereof.

3. The composition of claim 1, wherein the tackifier is selected from the following:
a) a hydrocarbon tackifier that has a cloud point (DACP) temperature greater than, or equal to, 20° C.,
c) a terpene tackifier, or
d) a combination thereof.

4. The composition of claim 1, wherein the tackifier is selected from the following:
b) a rosin ester tackifier with an acid number of less than 25,
c) a terpene tackifier, or
d) a combination thereof.

5. The composition of claim 1, wherein the tackifier is selected from the following: a) a hydrocarbon tackifier that has a cloud point (DACP) temperature greater than, or equal to, 20° C.

6. The composition of claim 1, wherein the tackifier is selected from the following: b) a rosin ester tackifier with an acid number of less than 25.

7. The composition of claim 1, wherein the tackifier is selected from the following: c) a terpene tackifier.

8. The composition of claim 1, wherein the tackifier has a cloud point (DACP) temperature from 20° C. to 110° C.

9. The composition of claim 1, wherein the tackifier has a cloud point (MMAP) temperature greater than, or equal to, 60° C.

10. The composition of claim 1, wherein the tackifier has a cloud point (MMAP) temperature from 60° C. to 110° C.

11. The composition of claim 1, wherein the tackifier comprises a C9 ring or ester groups.

12. An article comprising the composition of claim 1.

13. The article of claim 12, further comprising a substrate.

14. The article of claim 13, wherein the substrate is selected from the group consisting of the following: a coated substrate, a recycled paper, and combinations thereof.

15. The article of claim 13, wherein the substrate is selected from the group consisting of the following: wax coated Kraft or carton, polyethylene coated Kraft or carton, BOPP film laminated Kraft or carton, polypropylene (PP) film laminated Kraft or carton, PET film laminated Kraft or carton, clay coated Kraft or carton, lacquer coated Kraft or carton, and combinations thereof.
